(19) United States
(12) Patent Application Publication
(10) Pub. No.: US 2024/0069259 A1
(43) Pub. Date: Feb. 29, 2024

(54) PHOTOLUMINESCENT QUANTUM DOTS COLOUR FILTERS

(71) Applicant: Massachusetts Institute of Technology, Cambridge, MA (US)

(72) Inventors: Saurabh SRIVASTAVA, Singapore (SG); Li ZHANG, Singapore 138602 (SG); Kenneth Eng Kian LEE, Singapore (SG); Silvija GRADECAK-GARAJ, Singapore (SG)

(73) Assignee: Massachusetts Institute of Technology, Cambridge, MA (US)

(21) Appl. No.: 18/272,016

(22) PCT Filed: Jan. 13, 2022
(86) PCT No.: PCT/IB2022/050227

§ 371 Date: Jul. 12, 2023

Related U.S. Application Data
(60) Provisional application No. 63/136,816, filed on Jan. 13, 2021.

(51) Int. Cl. G02B 5/20

(52) U.S. Cl. CPC G02B 5/207; G02B 5/201; G02B 5/206

(57) ABSTRACT

The present invention describes photoluminescent apparatuses or colour filters (100a,100b,100c,100d) and methods (1000a,1000b) for manufacturing. A photoluminescent (PL) or quantum dot (QD) material (100) fills a pattern of trenches (40,42) formed on a surface or on opposite surfaces of an optically transparent substrate (20), being cured and sealed by an optically transparent cover (22); in another embodiment, the PL or QD material (100) are cured and sealed when two patterned optically substrates (20) are bonded together. Sealing of the PL or QD material in the trenches (40,42) preserves the optical and performance stability of these colour filters. These colour filters (100a, . . . 100d) are suitable for use in next generation UHD display screens or lighting applications.

### RELATED APPLICATIONS

The present invention claims priority to US provisional patent application no. 63/136,816 filed on 13 Jan. 2021, the disclosure of which is incorporated in its entirety.

### FIELD OF INVENTION

The present invention relates to photoluminescent quantum dots colour filter, which can be used in ultra-HD display screens, indoor or outdoor LED lightings, self-lighting LED display screens, LCD backlightings, and similar electronic components. These photoluminescent quantum dots also include quantum particles in the shape of rods, flakes and so on.

### BACKGROUND

Conventional high-definition display screens use blue LED light as back-light source. The blue light is then converted to red or green pixels on the display screen by phosphor coatings. These phosphor materials suffer from broad emission spectrum caused by yellow emission when blue light is down-shifted to green or red.

Newer thin-film electroluminescent quantum-dot LED (QLED) displays have demonstrated that quantum dots (QDs) are alternatives to provide pure colors on a wide color gamut. These QDs in colloids have size-tunable optical properties and narrow emission profiles in the visible spectral range, high quantum yield, and are amenable to low-cost wet-chemical processing. Colloidal QDs have already paved the way for applications in next-generation HD displays. However, the low luminous efficiency of blue compared to the green and red mono-color counterparts in such devices remains the limiting factor in terms of brightness.

Even newer photoluminescent QLED displays face difficulties. For example, these photoluminescent QLED displays require multilayer coatings of QDs, which require relatively thick films for near-complete absorption from the blue LED light source as compared to electroluminescent QLEDs. This multilayer coating process is tedious and time-consuming to perform economically. Also, QD-in-solution films are not chemically robust for post-processing. A solution is to coat dispersed QDs in a curable polymer matrix. However, these coatings suffer from gradual loss in color intensity and short QDs lifetime due to exposure to high photon fluxes or heat from the LEDs. Various deposition techniques, such as inkjet printing and nano-imprint lithography have been used to create high-density color pixels based on QD-in-polymer matrix system, but the deposition techniques make them time-consuming for large-scale production. Furthermore, the produced pixels suffer from deformed dimensions during UV-curing because of the viscous nature of the polymer matrix.

It can thus be seen that there exists a need to develop newer photoluminescent quantum dots QLED technology for display screens, for lighting or for photoelectronic components. Desirably, these PL QD materials have narrow and tunable optical emissions. However, along with the required well-defined pixel dimension, the PL QD materials also need to be chemically robust and optically stable under the illumination, while the small pixel size should be feasible. The method is not limited by the pixel size and can be scaled to any desirable pixel size.

### SUMMARY

The following presents a simplified summary to provide a basic understanding of the present invention. This summary is not an extensive overview of the present invention and is not intended to identify key features of the invention. Rather, it is to present some of the inventive concepts of this invention in a generalised form as a prelude to the detailed description that is to follow.

The present invention seeks to provide photoluminescent quantum dots colour filters and methods for manufacturing these colour filters. The present invention overcomes the conventional limitations by providing both monochromatic color filters and polychromatic (including RGB) colour filters to achieve high-purity color profiles, ultra-high pixel densities, with a longer life cycle. It is also desirable to tune the color temperatures (CCT) more precisely to provide dynamic display functionalities.

In one embodiment, the present invention provides a photoluminescent apparatus comprising: an optically transparent substrate formed on a surface with a pattern of trenches according to a desired pixel pattern, shape, size, depth and pitch; a photoluminescent material for filling the trenches; and an optically transparent cover for bonding over the optically transparent pixelated substrate surface and for sealing the photoluminescent material; wherein, when a light irradiates on the photoluminescent (PL) apparatus, the photoluminescent material responds by emitting a light of a characteristic wavelength.

Preferably, intensity and colour of the emitted light are tuned with a thickness of the PL material, when the trench dimensions according to the pixel pattern, shape, size and pitch are kept constant.

Preferably, a second surface of the optically transparent substrate is formed with a pattern of trenches according to a desired pixel pattern, shape, size and pitch, with pattern of trenches being different or the same pattern on the first surface, so as to produce a monochromatic filter with uniform emissions. Preferably, the two patterns of trenches and pixelated surfaces are arranged so as to form a colour filter with 3 emissions. Preferably, the two patterns of trenches and pixelated surfaces are formed on separate optically transparent substrates.

Preferably, the PL apparatus is a polychromatic or RGB colour filter. The RGB pixels can be aligned vertically, diagonally, spatially in a repeated pattern. The pixels can take on a variety of shapes and patterns. In one embodiment, the pixel size is substantially equal to the pixel pitch and the entire PL substrate is used for colour filtering.

In another embodiment, the present invention provides a method for manufacturing a photoluminescent colour filter comprising: forming a pixelated pattern on one side of a first optically transparent substrate by exposing selected areas on a first surface whilst blocking the rest of the first surface by a metallic layer; etching trenches with a predetermined depth at the selected areas to form a patterned first surface on the optically transparent substrate; coating a photoluminescent (PL) material in the trenches on the patterned first surface; curing the PL material; and encapsulating the PL material in the trenches by bonding a second optically transparent substrate over the patterned first surface on the first optically transparent substrate; wherein a thickness of the PL material being controlled by the predetermined trench depth determines an emission wavelength of a light irradiating on the PL material.

Preferably, the above method of manufacturing further comprises forming the patterned trenches, different from or similar to the first pattern, on a second side of the first optically transparent substrate with a second predetermined trench depth, so that light passing through the pattern of trenches and pixelated surfaces create a pattern of 3 lights following to the pattern, shape, size, pitch and density of the trenches. The second patterned side can be located on a second optically transparent substrate, and the two patterned surfaces are contacted and bonded together. When blue light is used as the light source, the colour filter becomes a RGB colour filter.

### BRIEF DESCRIPTION OF THE DRAWINGS

This invention will be described by way of non-limiting embodiments of the present invention, with reference to the accompanying drawings, in which:

FIGS. 1A-1B illustrate uses of QD enhancement film and QD colour filter in known display screens;

FIGS. 2A-2C illustrate photoluminescent QD colour filters according to an embodiment of the present invention;

FIGS. 3A-3J illustrate a lift-off photolithography process for forming the colour filters shown in FIGS. 2A-2C, whilst FIG. 3K-3M illustrate a direct photolithography process;

FIGS. 4A-4B illustrate tests on the mono-chromatic colour filters shown in FIGS. 2A-2B;

FIGS. 5A-5B illustrate two types of the RGB colour filters shown in FIG. 2C and FIGS. 5C-5K illustrate a process for forming the first type of RGB colour filter; whilst FIGS. 5L-5O illustrate different patterns and arrangements of the RGB pixels;

FIGS. 6A-6E show micrographs and colour characteristics of the colour filters obtained with the present invention;

FIGS. 7A-7L illustrate colour characteristic with variations of thicknesses of the QDs;

FIGS. 8A-8F illustrate colour characteristics of the above colour filters are stable at high photo-illuminescent intensities;

FIGS. 9A-9H illustrate the PL fillings in the trenches are uniform;

FIGS. 10A-10C illustrate the PL emissions when irradiated with a deep-blue light; and

FIGS. 11A-11E illustrate a combination of green PLs and red PLs for creating the white-emission colour filter of the present invention;

### DETAILED DESCRIPTION

One or more specific and alternative embodiments of the present invention will now be described with reference to the attached drawings. It shall be apparent to one skilled in the art, however, that this invention may be practiced without such specific details. Some of the details may not be described at length so as not to obscure the present invention.

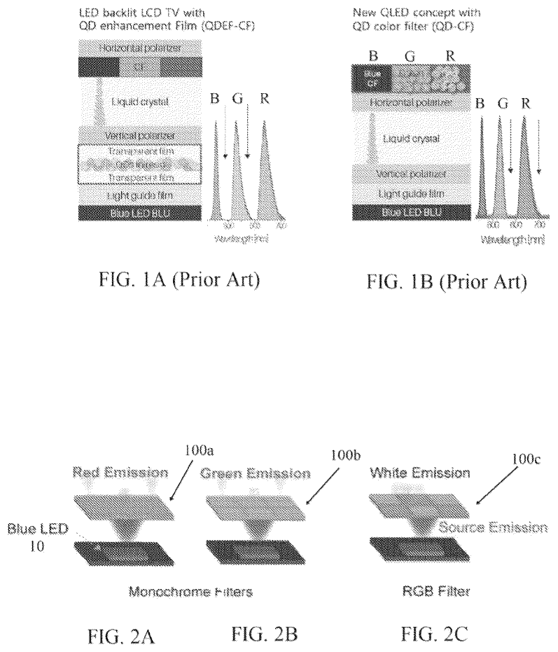

FIGS. 1A-1B show two known QLED displays. As discussed in the background, there are avenues to improve on these known QLED displays; these improvements are taught in the present invention:

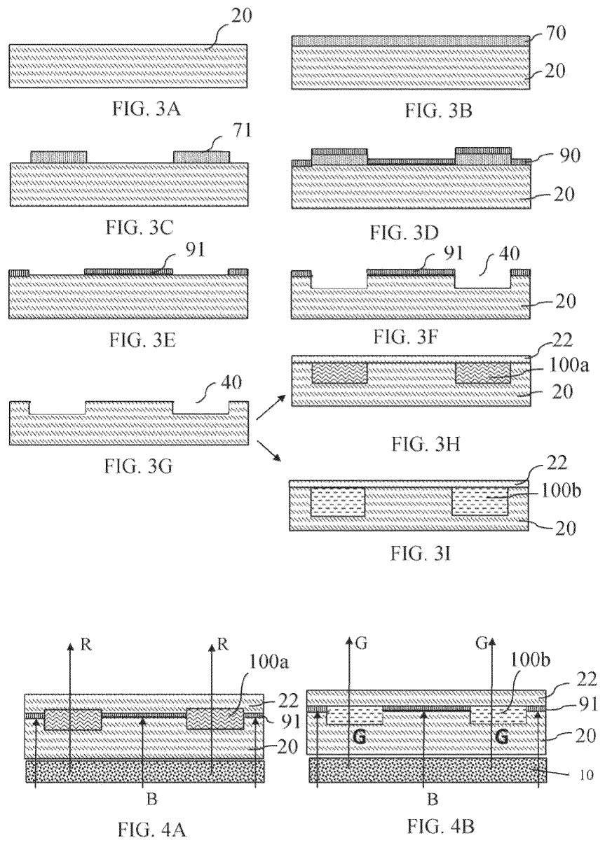

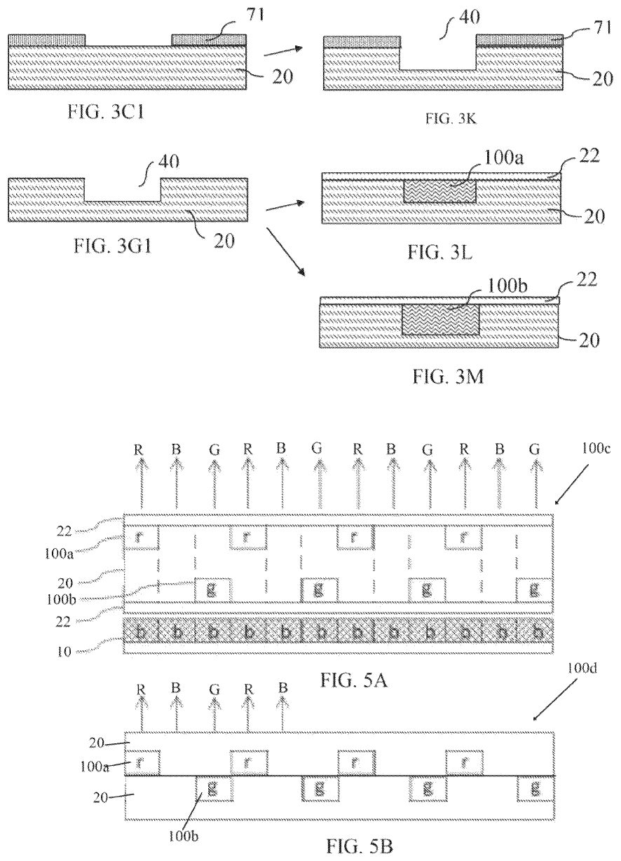

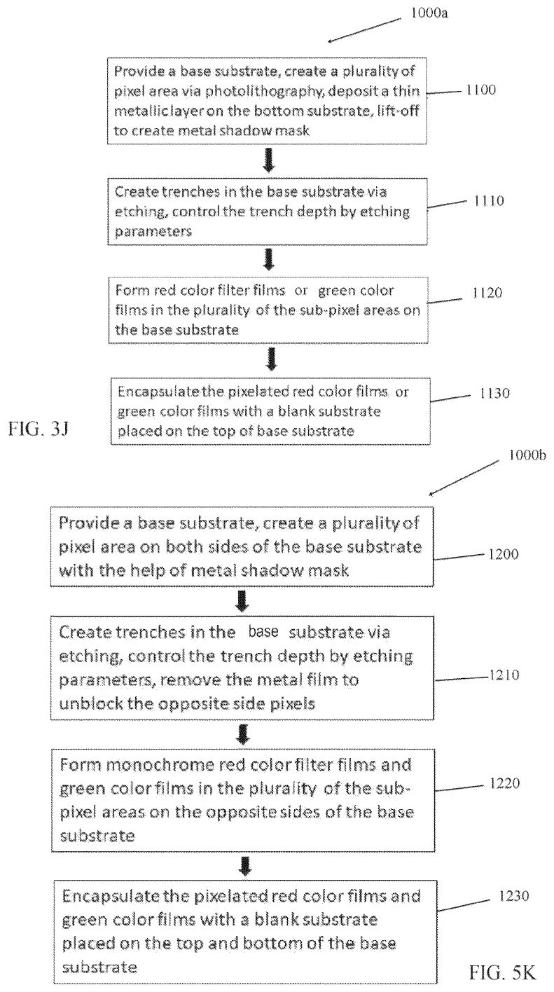

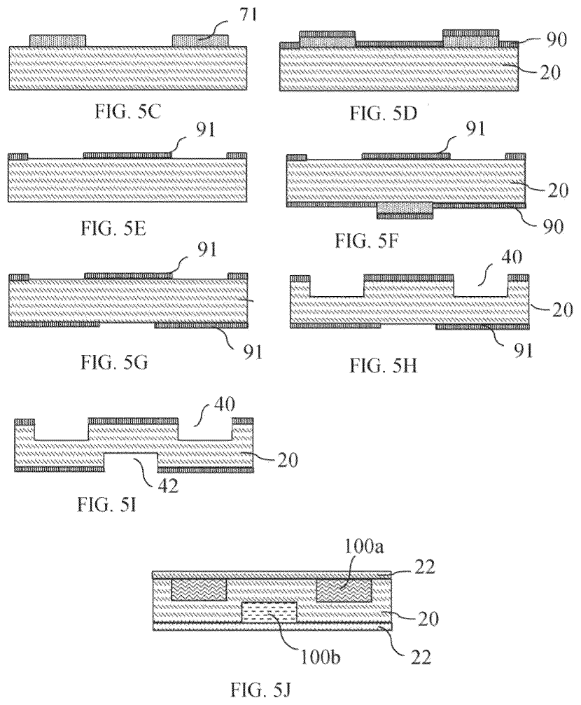

FIGS. 2A-2C show colour filters 100a,100b,100c obtained with the present invention and FIGS. 3A-3M and 5A-5K show the processes used in forming these colour filters. In FIGS. 3A-3C, a first optically transparent substrate (such as, quartz) 20 is prepared, coated with a photoresist 70 and photo-lithographically processed to form a patterned photoresist layer 71. In FIG. 3D, a metal layer 90 (such as, nickel) is formed on the partially processed substrate 20, and in FIG. 3E, the metal layer 90 is lifted off to create a patterned metal layer 91; this patterned metal layer 91 is used as a metal shadow mask to form trenches 40 that define the positions of pixels on the colour filters 100a,100b,100c. In one embodiment, these trenches 40 are formed by using reactive ion etching (RIE). RIE is preferably employed because it gives the advantages of steep trench walls and controlled depth of etching. Preferably, these trenches 40 have a uniform areal shape, size, pitch and density but the depths are controlled to two predetermined depths, meaning two patterned first substrates are obtained, as shown in FIG. 3F. In FIG. 3G, the patterned metal layer 91 is removed, and then in FIGS. 3H and 3I, the patterned substrates are coated with a photoluminescent (PL) material 100 or quantum dots (QDs) (such as, CdSe/ZnS core-shell QDs); in one embodiment, the PL material 100 is suspended in a curable polymer matrix to fill the patterned trenches 40. As an example, the PL material 100 coating can be spin-coated, drop-coated, and other techniques are also possible. After curing the polymer matrix (for example, with 365 nm UV or heat) to obtain pixels 100a with red emission when irradiated with blue light (where the PL material thickness of substantially 5 μm is controlled by the trench depth) or pixels 100b with green emission when irradiated with blue light (where the PL material thickness is substantially 7 μm), a second optically transparent substrate 22 or cover (such as, quartz) is bonded or sealed over the patterned first substrate 20 to encapsulate the PL material 100; thus, with the above process of the present invention, a red colour filter 100a or a green colour filter 100b is obtained. This process 1000a is summarized in a flow-chart, as shown in FIG. 3J, where the lithographic process 1100 includes the trench etching process 1110, the PL material coating and polymer curing process 1120, and the PL material encapsulating process 1130.

FIGS. 3K-3M show a direct lithographic process according to another embodiment. Only part of this direct lithography process is described: starting from the partially processed optically transparent substrate 20 shown in FIG. 3C1, the substrate with patterned photoresist 71 is etched to form trenches 40, as shown in FIG. 3K. The patterned substrate obtained (as shown in FIG. 3G1) is then coated to fill the trenches 40 with a suspension of the PL material 100 in a curable polymer matrix. The polymer matrix is then cured (for eg. in UV light or with heat) to obtain red pixels 100a with PL material thickness of substantially 5 μm (as shown in FIG. 3L) or green pixels 100b with PL material thickness of substantially 7 μm (as shown in FIG. 3M) when used with a blue light source 10. As in the above embodiment, the PL materials 100 are then encapsulated by bonding or sealing a second optically transparent substrate or cover 22 over the patterned optically transparent substrate 20.

To test and verify the performance of the above colour filters 100a,100b, the patterned substrate shown in FIG. 3F with the patterned metal layer 91 is coated with the PL material 100, which is then cured to obtain red pixels 100a with PL material thickness of substantially 5 μm or green pixels 100b with PL material thickness of substantially 7 μm when irradiated with the blue light source 10. As shown in FIGS. 4A-4B, a second optically transparent substrate or cover 22 is encapsulated over the first substrate 20 to seal the PL material 100 in the trenches 40. Each of the colour filters obtained 100a,100b is then tested for colour emission of the PL material formed at two thicknesses when irradiated or excited by blue light 10. These PL emission characteristics are further described below.

With the above process 1000a for manufacturing these two colour filters 100a,100b, we now turn to describe a manufacturing process 1000b for forming the polychromatic colour filter 100c (which includes a RGB colour filter). Two embodiments of the polychromatic or RGB colour filters 100c,100d are shown in FIGS. 5A-5B.

FIGS. 5C-5J and 5K show the polychromatic or RGB manufacturing process 1000b. Some of the process steps are similar to those described above, such as those shown in FIGS. 5C-5E, so only some process steps are now described. In FIG. 5F, the second, opposite surface of the partially processed optically transparent substrate 20 is formed with a patterned photoresist 71 and metal layer 90. FIG. 5G shows the metal layer 90 on the second substrate surface being lifted-off. FIG. 5H shows the patterned substrate 20 is etched with trenches 40 on the first surface, whilst FIG. 5I shows trenches 42 are etched on the second, opposite surface. Trenches 40 have a first depth whilst trenches 42 have a second depth. These trenches 40,42 are then filled with the PL material 100 to form pixels 100a,100b; as in the above process 1000a, the polymer matrix is cured and the PL material 100 is then encapsulated by bonding or sealing each of the two substrate surfaces with a blank optically transparent substrate or cover 22.

In FIGS. 5A, the first optically transparent substrate 20 is patterned with trenches 40,42 on two opposite surfaces, with the predetermined depths of the trenches for forming red and green pixels 100a,100b. In one embodiment, the trench patterns on the two opposite substrate surfaces are of different patterns or the same pattern. In one embodiment, the upper trenches 40 are offset from the lower trenches 42 (as seen in the figures) so that blue light 10 radiating from the bottom (as seen in FIG. 5A) generates a desired pattern of red, green and blue emissions or rays. In one embodiment, the areal surface of the pixels 40,42 is uniform. In one embodiment, the entire patterned surface is used for light transmission through this polychromatic or RGB colour filter 100c. Ultra high-density trench density and correspondingly ultra high-density pixel density is thus achievable because the trenches 40,42 are formed on opposite sides of the first substrate 20.

FIG. 5B shows another embodiment of a polychromatic or RGB colour filter 100d obtained using some relevant process steps shown in FIG. 5K. As shown in FIG. 5B, the polychromatic or RGB colour filter 100d is formed on two patterned optically transparent substrates 20, which are then bonded together with the two patterned surfaces in contact with each other. In one embodiment, the patterned surfaces are of different trench patterns or the same trench pattern. In one embodiment, when the trench patterns on the two patterned substrates 20 are of the same trench pattern, the patterns are offset from one another when the two patterned substrates 20 are bonded together. In another embodiment, when the two patterned substrates 20 are formed identically with the same trench pattern, the two substrates are offset when bonded together to obtain the above RGB colour filter 100d. In one embodiment, the trench 40,42 (patterns (and the obtained pixels 100a,100b) do not overlap, so that light emitted through the pixels 100a,100b and non-pixelated surface on the optically transparent substrate(s) 20 forming the polychromatic or RGB colour filter 100c,100d produces pure white emission or is tunable to emit any shades of a desired colour.

In one embodiment, the trenches 40,42 have an area size of about 5 μm×5 μm. Depending on the desired pixel density, it is possible to create other trench sizes, ranging from about 1 μm to about a few 100 μm. Other trenches of arbitrary shapes are also possible, such as, polygon of 3 or more sides, and even with trench pitches substantially equal to the trench sizes, in order to occupy the entire surface area of the patterned substrate 20 for making the colour filters 100a,100b,100c,100d of the present invention. Desirably, a pixel density is about 3600 ppi, about 5000 ppi or more depending on the pixel areal sizes and shapes. Of course, any lower pixel density is achievable, such as, 200 ppi. FIGS. 5L-5O illustrate different pixel shapes, sizes, pitches and arrangements that can be used with the present invention. In FIG. 5L, the pixels are shown to be substantially square in shape, where the R, G and B pixels are each aligned vertically, whereas in FIG. 5M, the R, G and B pixels are each aligned diagonally. FIG. 5N shows the R, G and B pixels are arranged in a hexagonal pattern, whereas FIG. 5O shows the R, G and B pixels are arranged within a hexagon. Other arbitrary shapes of the R, G and B pixels and different patterns of arrangements are also possible.

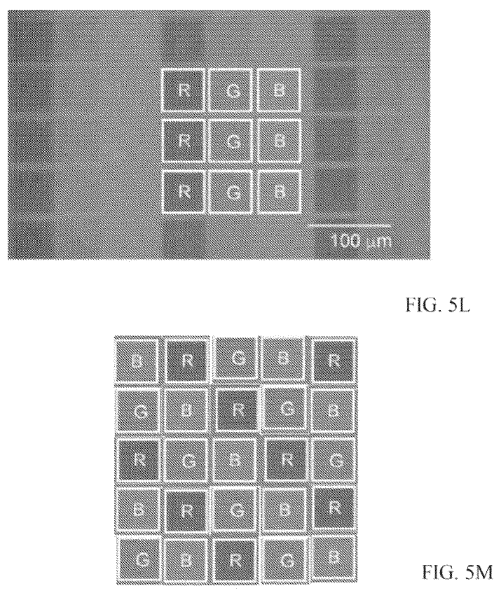

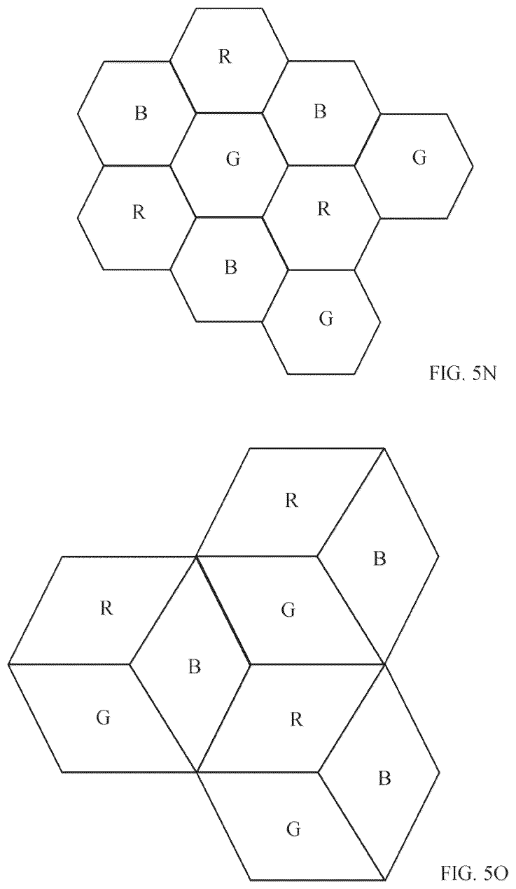

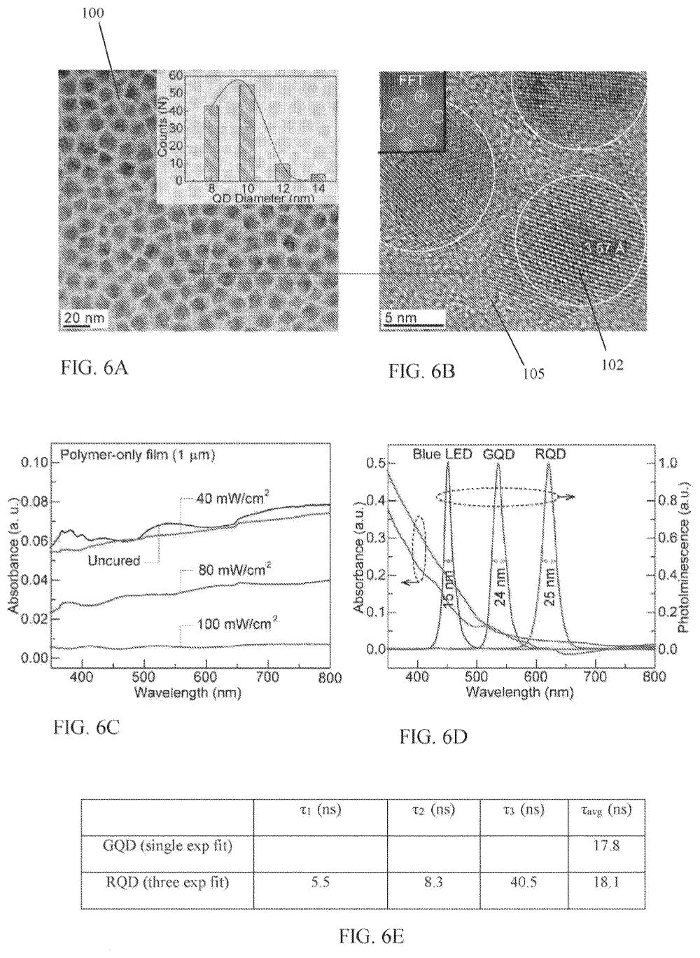

FIGS. 6A-6E show characteristics of the CdSe/ZnS QDs 100 embedded in the curable polymer matrix of the present invention. In particular, FIG. 6A shows HR TEM image of the QDs suspended in colloidal form in the curable polymer matrix with an insert showing a size distribution plot. The QDs are observed to be near-monosized (˜10±2 nm dia.) and uniformly dispersed. FIG. 6B shows high-magnification TEM image of individual QDs with FFT of single QDs in the inset. FIG. 6C shows UV-vis absorption spectra for the polymer-only films coated on the substrate 20 at different UV curing parameters. The polymer film cured at 100 mW/cm2 for substantially 60 sec is found to be near-optically transparent. FIG. 6D shows UV-vis absorption and photoluminescence emission spectra of the red and green quantum dots 100a,100b embedded in the polymer matrix (in the thin-film form). The PL emission peak at 450 μm is that of the blue LED light 10 source. To investigate the effect of the photoluminescence (PL) emission kinetics of the colloidal QD films, time-resolved photoluminescence measurements for red and green QD films on the substrates 20 were performed, excited using a pulsed diode laser (PicoQuant Fluo Time 200) at 375 nm. The results showed the lifetime decays (ravg) of the QD films to be 17.8 ns and 18.1 ns for red and green QDs 100a,100b, respectively (as seen in FIG. 6E). These average lifetime values are either similar to, or higher than, those reported for typical CdSe/ZnS core-shell QDs which indicates the good optical stability of these QDs. A single exponential fit provides the decay lifetime for the red QD film, however, for the green QD film, the lifetime is determined by the amplitude average lifetime values (fit by three exponentials)

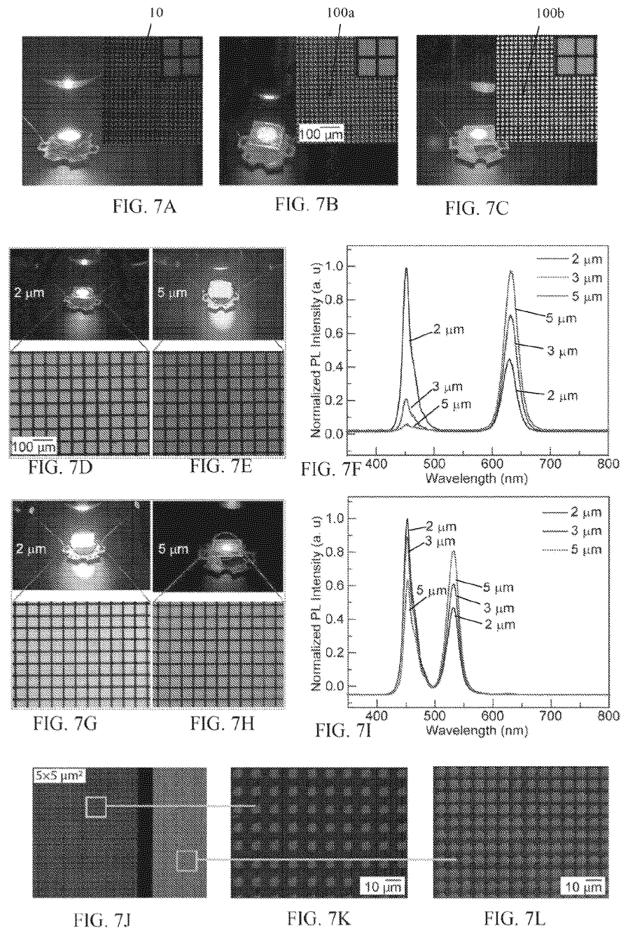

FIGS. 7A-7C show images of the PL or QD colour filters 100a,100b obtained where a blue LED 10 light of 450 nm is used as the source to optically excite the red and green PL or QDs to emit their corresponding wavelengths. The inserts are the commercial GaN LED used for the blue backlight source and high-magnification optical images of the corresponding green (right) and red (middle) colour filters. FIGS. 7D-7I show the color conversion from blue to green and from blue to red for two different PL or QD 100 layer thicknesses (2 μm and 5 μm), which were controlled by the etch depth on the optically transparent substrate 20. A color gradient is observed in-between pure blue GaN-LED and pure-red emission depending on the thickness of the PL or QD film in each pixel. The magnified optical images in FIGS. 7D, 7E, 7G, 7H show the size and pitch of the pixels whereas the black area is Ni shadow mask 91 to block the light coming from the back. Since the RIE process tends to create trenches with sharp edges and smooth sidewalls, the color pixels 100a,100b are well defined and uniformly-lit. The role of PL or QD layer thickness on the photoluminescence properties is then investigated. The photoluminescence spectra in FIGS. 7F and 7I show the PL intensity vs wavelength for blue vs green emission (FIGS. 7G-7H) and blue vs red emission (FIGS. 7D-7E) for different PL film thicknesses. As evident, the blue LED emission centered at 450 nm decreases with the increase in the green and red QD film thicknesses. Based on the PL intensity, the optimum thickness of the red PL or QD layer, for the given PL or QD density in the polymer matrix, is observed to be substantially 5 μm for near-unity conversion. This thickness requirement is also confirmed by comparing the thickness-dependent UV-vis absorption spectra. The green PL or QD films tend to show lesser absorption as compared to red PL or QD films within the same wavelength range, which indicates that a thicker green PL or QD film would be required for higher absorption. This directly translates into the thickness-dependent PL spectra for green PL or QD film of the same thickness as red PL or QD films, for near-unity conversion from the underlying blue light 10 source. Depending on specific properties of the QD and/or illuminating LED, the ideal thickness might vary. The lower relative peak height of the converted light in blue-->green vs blue-->red might also be explained by increased Auger/FRET (Forster Resonance Energy Transfer), where, a thicker film may provide more trapping sites for non-radiative recombination centers and gives rise to Auger recombination and Forster Resonance Energy Transfer. FIGS. 7J-7L show two patterns of pixel sizes and pitches used in the above tests.

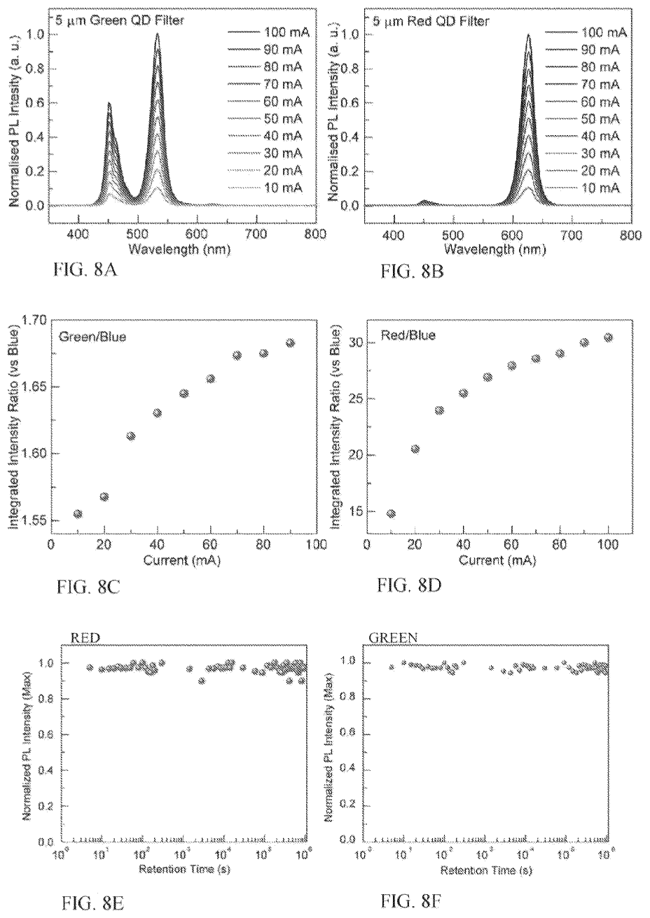

The PL or QD layer thickness is found to correlate directly with the depth of the trenches 40,42 created on the optically transparent substrate 20 before PL or QD encapsulation. To investigate the excitation intensity-dependent conversion efficiency of these monochromatic color filters, the PL spectra for both red and green colour filters 100a,100b were observed with respect to an injection current. FIGS. 8A-8B show the PL intensity vs injection current levels for red and green PL or QD colour filters, respectively, with a PL or QD film thickness of substantially 5 μm. A clear trend of increase in the red and green peak intensities are observed with increasing injection current values. Further, the integrated intensity ratios of red vs blue and green vs blue, in FIGS. 8C-8D show that there is a slight but constant increase in the ratio, which means the optical down-conversion from blue-to-red and blue-to-green is higher at higher injection current values. In other words, the PL spectra intensity and colours can be controlled by the injection currents to LED light sources 10. No peak shift in PL spectra (532 nm for green and 625 nm for red) and no FWHM broadening is observed for any other colour. This stability study is further supported by time-dependent optical retention by applying a constant injection current of 20 mA on the blue LED light 10 source for 48 hours (as evident from FIGS. 8E-8F). Little to almost no degradation in PL peak intensities is observed after 48 hours of continuous current injection, which shows the tests were optically stable.

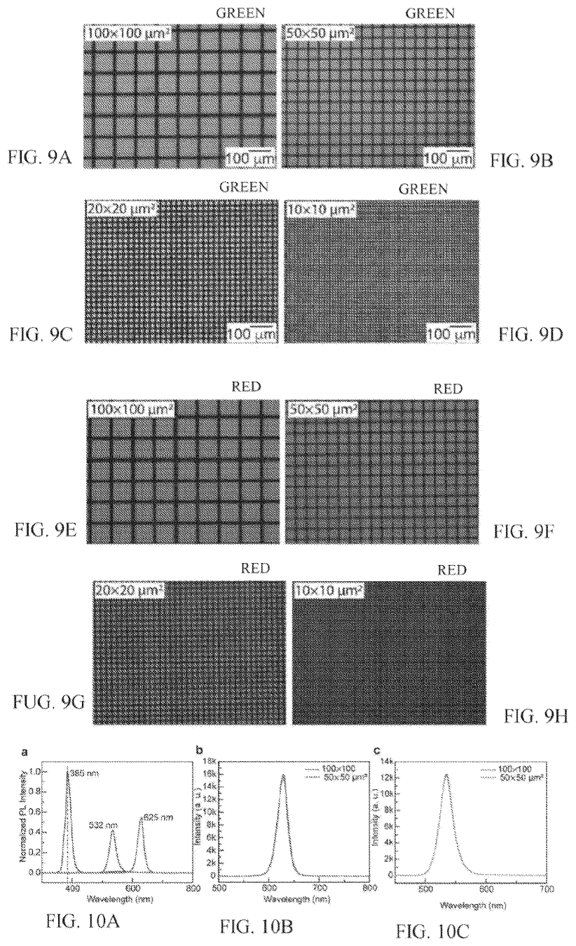

The above tests clearly show the emission of pure and highly saturated colors using the PL or QD colour filters 100a,100b,100c,100d of the present invention. Performance of a white color filter 100c,100d can be further optimized for the color temperature of emitted white light by controlling the amount of PL or QD loading for red and green colors via controlling either areal loading (pixel dimensions) or PL or QD layer thickness. Similar to the performance of the above monochrome color-filters 100a,100b, the PL intensity vs wavelength at different injection currents for the white-emission filter 100c,100d reveals an increase in intensity with the increase in injection current with no peak shift or peak broadening, which provides another confirmation of the excitation-intensity dependent conversion efficiencies of these PL or QD colour filters 100a, 100b. In addition, FIGS. 9A-9D and 9E-9H show that the PL or QD 100 filled the trenches 40,42 uniformly and the pixels obtained are well defined.

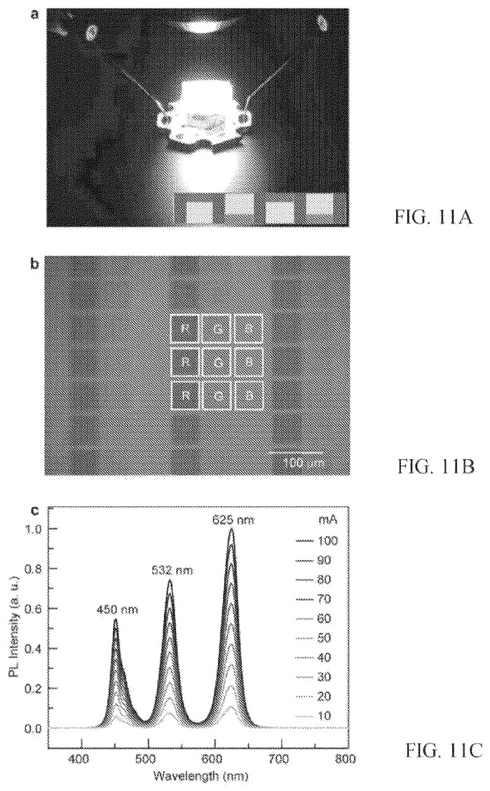

FIGS. 10A-10C show the above PL or QD colour filters 100a,100b,100c,100d are irradiated or excited with a deep-blue light at a wavelength of 385 nm and the PL peak emission intensities remain the same with blue light of 450 nm.

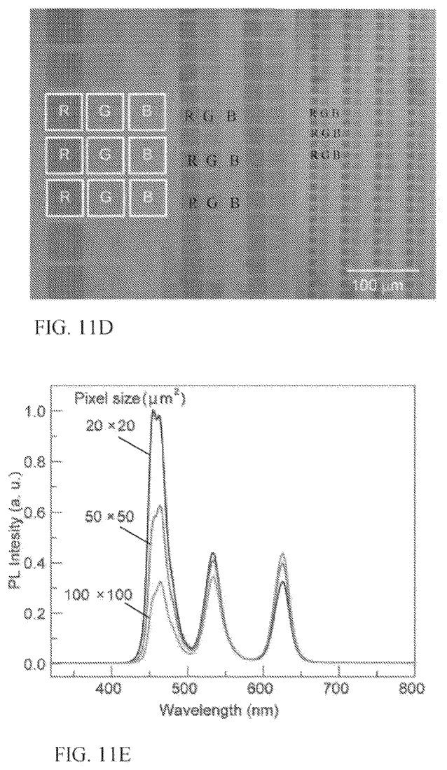

FIGS. 11A-11E show combination of green PL/QDs and red PL/QDs 100a,100b for creating the white emission filter 100c,100d. FIG. 11A shows an optical image of white-emission PL/QD colour filter 100c,100d when blue LED 10 is used as backlight (insert shows the cross-sectional schematic of the filter where green and red pixels are created on the same substrate but from opposite sides or on separate substrates). FIG. 11B shows high-magnification optical image of the colour filter showing individual red- and green-color pixels 100a,100b and emission of blue light from the remaining regions. FIG. 11C shows PL intensity vs wavelength for the white-emission at different injection current values. FIGS. 11D-11E show the polychromatic or RGB colour filters 100c,100d formed with different pixel sizes and the corresponding emission spectra. All three individual emission peaks with narrow FWHM appear without any peak shift or peak broadening, thus give evidence of suitability of using the PL or QDs 100 of the present invention to provide monochromatic red, green and polychromatic or RGB QD colour filters 100a,100b,100c,100d.

The color filters 100a,100b,100c,100d of the present invention have many advantages. For example, various kinds of photoluminescent quantum materials 100 (in the form of dots, rods, flakes, etc.), various optically transparent curable polymers, and various optically transparent substrates can be used. The present invention also provides a complete flexibility for creating pixels with different shapes, sizes, pitches and arrangements for different photonic applications. For example, quartz can be used for high-end displays, whilst optically transparent glasses can be used for lower priced lightings or luminaries. It is even possible to configure varying thicknesses of these photoluminescent material or QD 100 coatings in encapsulated trenches 40,42 to produce multi-coloured lights. These colour filters 100a,100b,100c,100d can also be tuned for other light sources, for example, as replacements of conventional 3-colour traffic signal lights or one traffic signal light with 3 switching colours. In addition, the polychromatic or RGB colour filters 100c,100d can be configured to produce white lighting apparatus and applications.

While specific embodiments have been described and illustrated, it is understood that many changes, modifications, variations and combinations of variations disclosed in the text description and drawings thereof could be made to the present invention without departing from the scope of the present invention. For example, (i) other optically transparent substrate (even flexible substrates) can be used for pixelation; (ii) the photoluminescent quantum dots 100 include particles in the shapes of flakes, rods, etc.; and (iii) other photoluminescent curable polymers can also be used. In the above description, CdSe/ZnS is used as an example of the PL or QD material 100; other possible PL or QD materials that can be used include: other Cd based core/core-shell quantum particles; Cd-free quantum particles; Pb based core/core-shell quantum particles; Pb-free quantum particles; and Perovskite quantum particles.

1-24. (canceled)

25. A photoluminescent apparatus comprising:
an optically transparent substrate formed on a surface with a pattern of trenches according to a desired pixel pattern, shape, size, depth and pitch;
a photoluminescent material for filling the trenches; and
an optically transparent cover for bonding over the optically transparent pixelated substrate surface and for sealing the photoluminescent material;
wherein, when a light irradiates on the photoluminescent (PL) apparatus, the photoluminescent material responds by emitting a light of a characteristic wavelength.

26. The photoluminescent apparatus according to claim 25, wherein the emitted light is dependent on a volume of the PL material as determined by the trench dimensions and a wavelength of the irradiating light; and
wherein the trench dimensions according to the pattern, shape, size and pitch are kept constant, whilst an intensity or wavelength of the emitted light is tuned according to a thickness of the PL material, thus providing a mono-chromatic colour filter with a single emission.

27. The photoluminescent apparatus according to claim 25, further comprising:
a pattern of trenches formed according to a desired pixel pattern, shape, size, depth and pitch on a second, opposite surface of the optically transparent substrate; and
an optically transparent cover for bonding over the second surface of the optically transparent pixelated substrate and for sealing the photoluminescent material.

28. The photoluminescent apparatus according to claim 27, wherein the patterns of trenches, so are the patterns of pixels, on the two opposites surfaces do not overlap, so as to provide a monochromatic colour filter with two emissions.

29. The photoluminescent apparatus according to claim 25, further comprising:
a second optically transparent substrate formed on a surface with a different or similar pattern of trenches according to the desired pixel pattern, shape, size, depth and pitch formed on the (first) optically transparent substrate; and
the two pixelated surfaces are bonded to each other to seal the PL material, such that the two surface patterns do not overlap each other, so as to provide a monochromatic colour filter with two emissions.

30. The photoluminescent apparatus according to claim 29, further comprising the desired pixel pattern, shape, size and pitch that is on the first or second optically transparent substrate being non-patterned, thus providing a monochromatic colour filter with two emissions and the irradiating light.

31. The photoluminescent apparatus according to claim 30 is configured as a RGB colour filter for a display screen.

32. The photoluminescent apparatus according to claim 31, wherein the R, G and B pixels include pixels that are diagonally aligned, arranged in a hexagonal pattern, and arranged within a hexagon.

33. The photoluminescent apparatus according to claim 25, wherein the pixel size and pixel pitch are substantially the same in both orthogonal axes.

34. A method for manufacturing a photoluminescent color filter for an ultra-high-definition display screen, the method comprises:
forming a pixelated pattern on one side of a first optically transparent substrate by exposing selected areas on a first surface whilst blocking the rest of the first surface by a metallic layer;
etching trenches with a predetermined depth at the selected areas to form a patterned first surface on the optically transparent substrate;
coating a photoluminescent (PL) material in the trenches on the patterned first surface;
curing the PL material; and
encapsulating the PL material in the trenches by bonding a second optically transparent substrate over the patterned first surface on the first optically transparent substrate;
wherein a thickness of the PL material being controlled by the predetermined trench depth determines an emission wavelength of a light irradiating on the PL material.

35. The method according to claim 34, wherein the pixelated pattern is formed by using the processes of photolithography and metal sputtering; and
wherein the process of photolithography is by a lift-off technique.

36. The method according to claim 34, further comprises:
etching the trenches by reactive ion etching (RIE) to produce uniform predetermined trench depth, to provide uniform PL material coating thickness.

37. The method according to claim 34, wherein the PL material is suspended in a curable polymer matrix.

38. The method according to claim 34, wherein the PL material is selected from the following: CdSe/ZnS core-shell quantum particles, Cd based core/core-shell quantum particles; Cd-free quantum particles; Pb based core/core-shell quantum particles; Pb-free quantum particles; and Perovskite quantum particles.

39. The method according to claim 34, wherein the PL material thickness is timed for green or red conversion from a blue, deep-blue, UV or deep-UV light source.

40. The method according to claim 34, further comprises:
forming the patterned trenches, similar as or different from the first pattern, on a second, opposite side of the first optically transparent substrate with a second
predetermined trench depth, so that light passing through the pixelated surfaces and the first optically transparent substrate create a pattern of 3 lights following the pattern, shape, size, pitch and density of the trenches.

41. The method according to claim 40, wherein when trenches are deposited with the PL material and after being cured, the PL materials on the two opposite sides of the first optically transparent substrate give separate red or blue emission when blue light is used as the light source, thereby creating a polychromatic or RGB colour filter.

42. The method according to claim 41, wherein the polychromatic or RGB colour filter occupies the entire patterned surface of the first optically transparent substrate.

43. The method according to claim 34, further comprises:
forming a pixelated pattern on one side of a second optically transparent substrate by exposing selected areas on a first surface whilst blocking the rest of the first surface by a metallic layer; and
contacting together the pixelated patterned surfaces of the first and second optically transparent substrates and bonding together the first and second optically transparent substrates.

44. A photoluminescent colour filter obtained with the method according to claim 34 for producing monochromatic red or green down-conversion spectra emission, or for producing a polychromatic or RGB colour filter when used with a blue light source.
